(19) United States
(12) Patent Application Publication
(10) Pub. No.: US 2023/0263141 A1
(43) Pub. Date: Aug. 24, 2023

(54) INTELLIGENT WATERBODY MANAGEMENT SYSTEM

(71) Applicant: BARIFLOLABS PRIVATE LIMITED, Bolangir (IN)

(72) Inventor: Mrutyunjaya SAHU, Bolangir (IN)

(21) Appl. No.: 18/012,669

(22) PCT Filed: Jun. 23, 2021
(86) PCT No.: PCT/IN2021/050611

§ 371 Date: Dec. 23, 2022

(30) Foreign Application Priority Data
Jun. 24, 2020 (IN) 202031026796

(51) Int. Cl. A01K 63/04; C02F 7/00; C02F 1/00; A01K 61/80; A01K 61/13

(52) U.S. Cl. CPC A01K 63/042; A01K 61/13; A01K 61/80; C02F 1/008; C02F 7/00; C02F 2209/001; C02F 2209/008; C02F 2209/02; C02F 2209/04; C02F 2209/06; C02F 2209/11; C02F 2209/22; G16Y 40/35

(57) ABSTRACT

The current invention relates to an artificial intelligence, internet of things (IoT) based water body management system. The water body management system of the invention comprises of an aeration module, a nutrient dispensing module, and a sensor module which monitors and maintains water quality parameters. The artificial intelligence module configured with the sensor module trains the data obtained from the sensors and inputs to the aeration, nutrient dispensing or other modules. The current invention has applications in aquaculture management, management of water bodies like lakes, reservoirs, and ponds.

### FIELD OF INVENTION

The current invention relates to the field of an artificial intelligence (AI), internet of things (IoT) based water body management system. The invention relates to aquaculture management by intelligent aeration, nutrient control, monitoring and maintaining water quality parameters at desired levels by modulating the function of aeration, nutrient control, and/or water recycling.

### BACKGROUND

Deep confined water bodies generally have a depth of 5-45 m. In such confined water bodies, the seasonal variation due to daytime solar radiation forms three layers of temperature structure i.e. epilimnion, thermocline and hypolimnion. The thermocline acts as a barrier and doesn’t allow free passage of oxygen to the hypolimnion and exacerbates anoxic conditions. Compounds released from the sediment during anoxic condition dramatically affect water quality. Stratification leads to presence of lower density water at the top and higher density water stays at bottom further impede transmission of oxygen to the sediment from the atmosphere. Stratification periods tend to be longer during summers. This further inhibits consumption of oxygen by bacteria and other microorganisms at the sediment. Generally, bacteria utilize dissolved oxygen (DO) for the breakdown of biological matter such as dead phytoplankton, generating more phosphorous and nitrogen in an aquatic system. The abundant supply of phosphorous and nitrogen lead to growth of phytoplankton and eutrophication along with formation of hypoxic zones. Such anaerobic conditions lead to the formation of hypoxic zones, resulting in release of a range of toxic compounds from the sediment. Presence of feed and excreta of animals are significant factors that lower dissolved oxygen (DO) in the system. Absence of oxygen leads to enhancement of ammonia, nitrate, phosphate and also helps in growth of pathogenic bacteria at the sediment, leading to disease and mortality of aquatic animals. Among the toxic compounds from the sediment, ammonia has significant effect on water quality degradation and poses a risk to aquatic habitat particularly at an elevated pH. Further presence/entrapment of nitrogen in the form of ammonia and nitrate is also a key limiting factor for availability of nutrient. Moreover, unavailability of oxygen and reduction of redox potential at the sediment promote the release of Manganese (Mn), Iron (Fe), Phosphorus (P) via microbial and chemical reduction of metal oxides. Further, Phosphorous and Nitrogen (N) released from sediment diffuse to surface water and enhance the growth of phytoplankton. In addition, under anaerobic conditions sulfate-reducing bacteria become active leading to sulphide accumulation at the sediment. The resulting hydrogen sulfide is very toxic for aquatic life. Moreover, during very high redox conditions methyl-mercury is produced by methylation of dissolved inorganic mercury by anaerobic bacteria present in sediments. These nutrients accumulate with time and degrade the water quality of the waterbody. Furthermore, growth of N, P facilitates the growth of blue-green algae resulting in eutrophication. It is thus, imperative to provide adequate oxygen to the sediment so that the release of undesirable compounds can be reduced. Inducing a water current with velocity between 3-8 cm/s at the sediment-water interface helps in maintaining sufficient oxygen so that release of harmful compounds can be prohibited. Further the current enhances sediment oxygen demand (SOD) by four fold. Mainly under quiescent hydrodynamic and anaerobic conditions the sediment boundary layer becomes thick and oxygen infiltration to the sediment becomes restricted. The mixing at the sediment surface breaks the barrier as the sediment boundary layer between the sediment water interface which enhances oxygen uptake by the sediment. Moreover, sediment oxygen demand (SOD) uptake also depends on the morphometry of the waterbody.

Till now, various oxygenation systems have been deployed in water bodies. Among these oxygenation systems, hypolimnetic oxygenation systems fit the requirement and are most adopted as oxygenation of hypolimnion keeps bottom water cool, unlike destratification system which mixes water column and raises the temperature of hypolimnetic water which is deleterious for the aquatic life. Also, destratification systems which mix the water column of stratified water with higher capacity, are very costly. Further, oxygenation at the water surface is not effective as oxygenating at the hypolimnion. Thus, hypolimnetic oxygenation systems are used to oxygenate at the hypolimnion of the water bodies. Diffuser systems like Speece Cone, airlift, and bubble plume type systems are used to reduce oxygen demand at the water bodies. These systems are generally deployed and fixed at the bed of the waterbodies (> 10 m) . In general, these systems raise the oxygen concentration at the hypolimnion without disturbing the stratification. It has been observed that, by the use of these aeration systems the depletion of oxygen can be restored and anoxic condition can be prevented under certain environmental conditions. However, the installation cost and maintenance is very expensive for developing countries such as India. Furthermore, hypolimnetic oxygenation fails when the mixing at the sediment water interface is not performed. Instances have been reported that despite oxygenation, hypoxia could not be obliterated. In addition to it, due to spatially fixed nature of the system, the aeration could not produce sufficient mixing farther from the diffuser, as the bottom turbulence is also dependent on the bottom bathymetry and traps oxygen within a limited region. Furthermore, the dispersion of the oxygen from the farther region requires sufficient lateral velocity without being trapped near the oxygenation systems.

US7396456B2 provides a paddle wheel based aeration system suitable for ponds. It aerates by pumping the aquatic water into the air. It is suitable for epilimnetic aeration. However, SOD demand is neglected. KR100951787B1 describes a floating and manoeuvring device by a motor underwater impeller for generating an upward flow of water in the stagnant body of water, which also increases DO. This device generates vertical water column mixing by the rotational driving of the motor underwater impeller for generating an upward flow of water. US20140110323A1 provides a device to remove contaminants by aerating. It floats freely and aerates the upper strata of the waterbody. Navigation is by remote control, GPS or autonomous control. The propeller receives energy from conventional source. This device does not solve eutrophication issue,is not intended for hypolimnetic aeration, thus does not meet SOD. WO2020046523A1 describes a computerized feed system that is trained to determine amount of feed and feed type to dispense in a time horizon. It describes a differential model which relates to rate of fish growth w.r.t relevant conditions.

The prior art lacks an integrated and efficient approach to aerate the hypolimnetic region and dispense nutrients while factoring in critical water quality and water body parameters. The current invention aims to provide by real time monitoring of various water quality parameters, carp parameters and provide corrective action by deploying the modules disclosed in the invention in a timely manner. The aeration system modulates oxygen and nutrient dispersal based on input derived using artificial intelligence.

The current invention provides a cost-effective solution that enables timely and corrective action for water body and aquaculture management using predicted values of a wide range of parameters including water quality parameters as predicted by the artificial intelligence module, based on parameters as sensed by sensors comprised in the sensor module.

### SUMMARY

The current invention discloses an autonomous and intelligent water body management system based on Internet of things (IoT) and Artificial Intelligence (AI).

One embodiment of the invention is a system for autonomous and intelligent management of waterbodies, the system comprising:
an aquaculture system, wherein the aquaculture system further comprises at least one aeration module, a nutrient dispensing module and a sensor module;
a communication gateway, wherein the communication gateway is a wireless communication hub which is configured to communicably connect with the aquaculture system;
a cloud computing module, wherein the cloud computing module is configured to connect with the Internet, the communication gateway and the aquaculture system through wired or wireless means; and,
wherein the aeration module, nutrient dispensing module and sensor module in the aquaculture system are each designed to comprise separate batteries as power sources for separate control modules, and wherein the sensor module is further configured with an Artificial Intelligence module. In one embodiment of the invention, the sensor module comprises a sensing module, a navigation module, a battery and a control module, and wherein the sensing module is an assembly of a plurality of sensors selected assembly of a plurality of sensors selected from depth sensors, dissolved oxygen (DO) sensors, ORP sensor, GPS sensors, sonar module, temperature sensor, pH sensor, turbidity sensor, proximity sensors, water current velocity measurement sensor, carp velocity sensor, carp acoustics sensors, IMU sensor.

In one embodiment of the invention the sensor module is configured to autonomously move to a plurality of coordinates in a water body along different strata, and wherein the autonomous motion of the sensor module is enabled by inputs from a plurality of sensors selected from GPS, IMU, position or proximity sensor comprised in the sensor module, and wherein the autonomous decision-making capability of the sensor module for motion in the water body is enabled by a computer-vision and GPS aspect of the Artificial Intelligence module.

In one embodiment of the invention the Artificial Intelligence module is configured to create a plurality of data training models based on the data input from sensors selected from depth sensors, turbidity sensor dissolved oxygen (DO) sensors, IMU sensors, GPS sensors, imaging sensors or computer vision, temperature sensor, water current velocity measurement sensor, weather parameters such as wind speed, wind direction, ambient temperature and humidity at the water surface, for prediction of DO gap, unionized ammonia, anaerobic conditions or a combination thereof.

In one embodiment of the invention the Artificial intelligence module is configured to predicts water quality parameters selected from DO, ammonia (NH4-N), unionized ammonia phosphate (PO4-), turbidity, salinity, temperature, pH, TSS (Total Suspended Solids),TOC (Total Organic Carbon) and ORP (Oxidation Reduction Potential), sulphide, phosphate, nitrite, nitrate, vibrio count, Carbon dioxide (CO2) capture, water column respiration rate, carps respiration rate, sediment respiration rate, C:N ratio, frequency of synchronous and asynchronous waves of aerator based on the data input from the sensor module.

In one embodiment, the aeration module comprises an air pumping module, an aerator, a control module and a battery, and wherein, the aeration module is designed to be physically placed in a water body and to aerate hypolimnetic or sediment regions of the waterbody based on input from the artificial intelligence module and preset configuration. In one embodiment, the aerator aerates a region by oscillating vertically in a sinusoidal manner, thereby generating standing waves and synchronous waves radially with a frequency and amplitude as determined by the input from the artificial intelligence module. In one embodiment the aerator is provided with mechanical wings that are designed to flap, in order to mimic ornithogenic disturbance with a frequency range as determined by the input from the artificial intelligence module. In one embodiment the aerator is a one or two-stage ring aerator with diffuser nozzles, gear box, a motor, a bearing holder, a spring pipe, a pulley holder a pulley belt, pneumatic pipes and connector configured with the air pumping module of the aeration module.

In one embodiment of the invention, nutrient dispensing module comprises a nutrient dispenser, a navigation module, a control module, a bioreactor and wherein, the nutrient dispensing module is designed to be physically placed in a water body and to autonomously move to a plurality of coordinates in a water body and dispense a plurality of nutrients housed in the dispensing module. In one embodiment, the input from the Artificial Intelligence module to the nutrient dispensing module in the form of trained data optimizes a plurality of parameters selected from time interval between dispensing nutrients, amount of nutrients to dispense, or the type of nutrients to be dispensed or a combination thereof. In one embodiment, the nutrient dispensing module comprises at least two valves and two tanks, and wherein, at least one of the tanks is detachable. In one embodiment of the control module in the nutrient dispensing module is configured to enable dispensing nutrients, drugs or probiotics when the concentration of unionized ammonia, nitrite, nitrate, sulphide, phosphate, vibrio count in the water body is observed to be in a range different from the preset range, and wherein, the sensor module is configured to sense the value of DO, pH, ORP, temperature, turbidity and the artificial intelligence module is configured to determine the timings and dosage of nutrients to be dispersed into the water body.

One embodiment of the invention is a method for autonomous and intelligent management of water bodies, the method comprising:
placing an aquaculture system in a water body, wherein the aquaculture system comprises at least one aeration module, a dispensing module and a sensor module, and wherein, a wireless communication hub is configured to communicably connect with the control modules in the aquaculture system;
determining a plurality of physical parameters of the water body through activation of a plurality of sensors in the sensor module;
analyzing the readings from the plurality of sensors in a cloud computing module enabled by the wireless communication hub;
providing suitable data as inputs to the Artificial Intelligence module in the sensor module for training data;
providing the output of the Artificial Intelligence module as command input to the aeration module and dispensing module;
navigating the sensor module or the dispensing module to suitable locations on the water body based on the inputs from Artificial Intelligence module;
activating at least one of the aeration module nearby to the coordinates or the dispensing module at the coordinates; and,
analyzing the change in the physical parameters of the water body at the location and deactivating the aeration module or the dispensing module. In one embodiment, the method of operation of the sensor module includes positioning the sensor module autonomously in a suitable location or grid point in the waterbody; sensing water depth, water quality parameters and at each grid point; measuring the changes in SOD, water quality parameters and weather information of the location and communicating the inputs to the Artificial Intelligence module; predicting the SOD for a preset future period and deciding the feeding pattern, the frequency of aeration oscillation for individual installed aerators, duration of aeration by a network of aerators, the type of probiotics to be dispensed and its dispensation parameters; and, checking whether a preset critical value of SOD unionized ammonia, sulphide, phosphate, nitrate, nitrite, vibrio growth and ORP have been attained at the location in the water body; when the critical value is sensed, then activating aeration and dispensing, and deactivating them when the preset conditions are satisfied.

### BRIEF DESCRIPTION OF FIGURES

FIG. 1. shows the diagram of Artificial intelligence, internet of things (IoT) integrated waterbody management system

FIG. 2. Shows the Sensor Module and its Components

FIG. 3. Shows a Block Diagram of the Intelligent Water Body Management System

FIG. 4. Shows Working mechanism of the Aeration Module

FIG. 5. Shows Working mechanism of the nutrient Dispensing Module

FIG. 6. Shows Functional components of Aerator, wherein (111a) Bearing holder,(111b) Motor,(111c) Pulley holder(111d)Pulley Belt, (111e) Spring pipe (111f) Two stage ring aerator with diffuser nozzles

FIG. 7. Shows the diagram of Artificial intelligence, internet of things (IoT) integrated waterbody management system with the Water Recycling Module

FIG. 8. Shows Work flow process of the Sensor Module

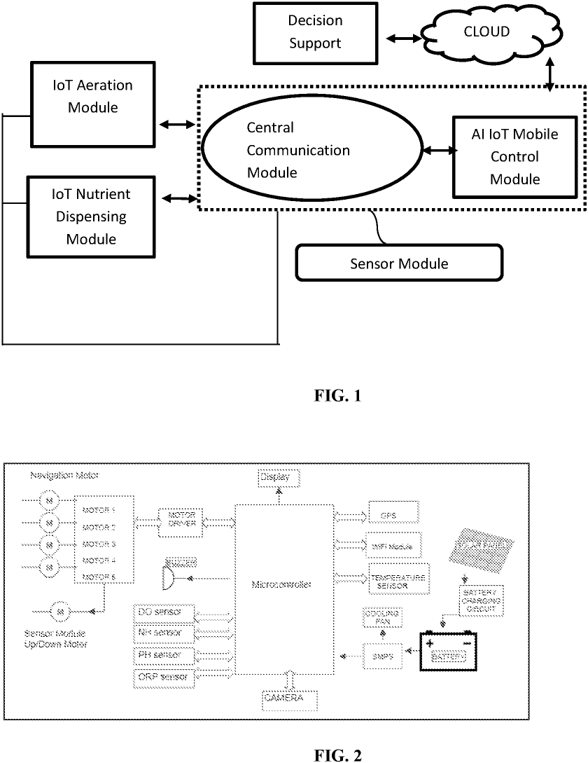

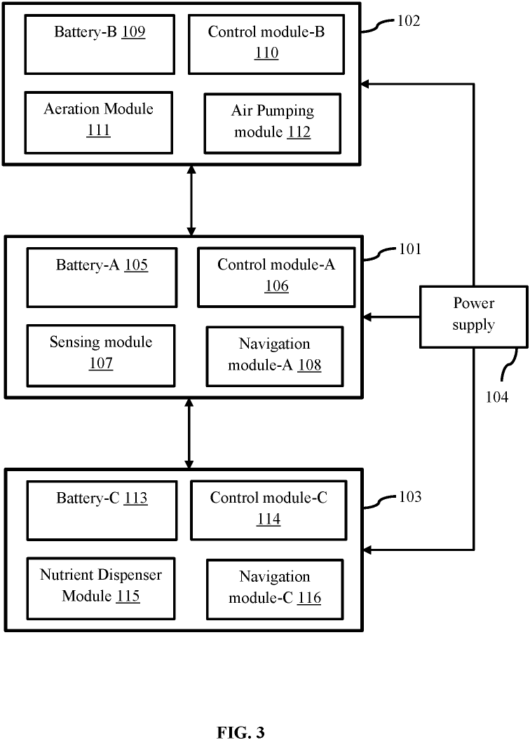

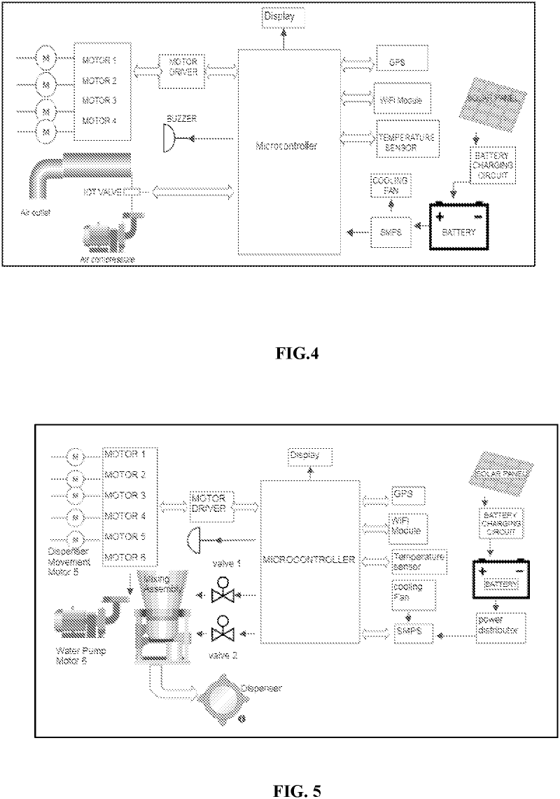

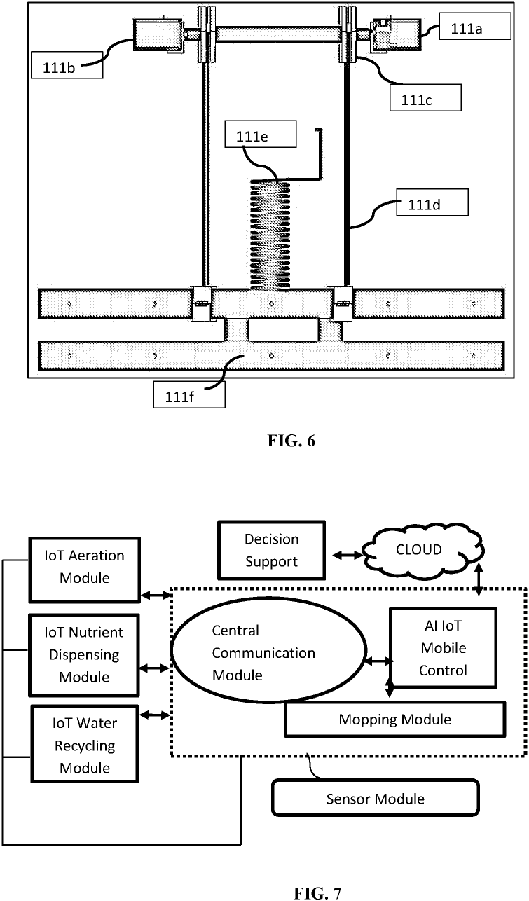

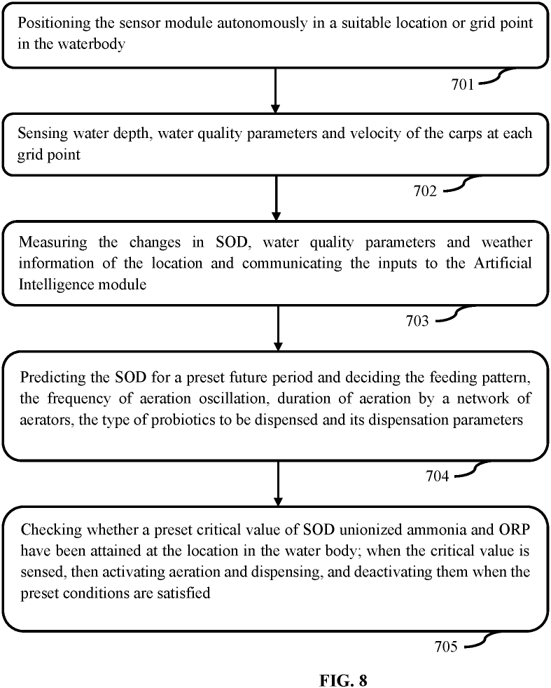

### DETAILED DESCRIPTION

The invention provides an Internet of Things (IoT) and artificial intelligence based autonomous water body management system. The invention specifically relates to aquaculture management by intelligent aeration, nutrient control, monitoring and maintaining water quality parameters at desired levels. The current invention has applications in aquaculture management, management of water bodies like lakes, reservoirs and ponds.

### Definitions

“Hypolimnetic aeration”, or “sediment aeration” as used herein refer to aeration of the hypolimnetic region to meet the sediment oxygen demand

“Artificial intelligence module” as used herein refers to a module that receives data from the sensors, compares it with values of pre existing sensor readings, desired value parameters and provides input to the control modules of one or more aeration modules, nutrient dispensing module. The module can lead to corrective action, opening or closing of valves or switches, or notify/alert on parameters. The module has machine vision capability as well as a GPS functionality. The module can create and utilize a plurality of data training models. It can involve various algorithms selected from an artificial neural network algorithm, a Gaussian process regression algorithm, a logistical model tree algorithm, a random forest algorithm, a fuzzy classifier algorithm, a decision tree algorithm, a hierarchical clustering algorithm, a k-means algorithm, a fuzzy clustering algorithm, a deep Boltzmann machine learning algorithm, a deep convolutional neural network algorithm, a deep recurrent neural network, or any combination thereof.The various models can train parameters without limitation, humidity, wind speed, wind direction, temperature of ambient and water column, water quality parameters such as temperature, DO, pH, ORP, at multiple coordinates of the same water body.

The training data generated through a repetitive process of randomly choosing values for each of one or more input process control parameters and scoring adjustments to the input process control parameters as leading to either undesirable or desirable outcomes, the outcomes based respectively on the presence or absence of defects detected in a fabricated object arising from the process control parameter adjustments.

The training data set further comprises process characterization data, in-process inspection data, or post-build inspection data that is generated by an operator while manually adjusting the process control parameters.

“Ammonia” refers to unionized and ionized ammonia.

“Battery” as used herein is used interchangeably with electricity, to power the device.

“Carp” includes aquatic species like fishes, crustaceans including shrimps, prawns, crabs, lobsters or molluscs.

“Sensor module” as defined herein is Sensor module is a collection of various sensors including water quality sensors, carps sensors including carps movement, acoustics, respiration rate, and also image capturing devices .Sensors store data on the cloud and also locally. Sensor module houses an artificial intelligence module in its control module. The data is later used for directing inputs to the aeration, nutrient dispensing module or the sensor module or any other module.

“Grid” as defined herein is a two dimensional plane to precisely locate the position of bot within the waterbody

“Control module” as defined herein is a unit to transmit and receive data from and to other modules. It can also be termed as a communication module, to receive data from the AI module. It comprises a microcontroller/microprocessor and a wifi component. It may contain other components based on the functions of the system or a module of which it is a part. These are computing devices with digital storage and digital processing capabilities. The module may comprise an image capturing device or navigation module.

“DO gap or Dissolved Oxygen Gap” as used herein refers to the gap between the existing level of Dissolved oxygen and the demand for Dissolved oxygen at the sediment water interface of the waterbody. The demand for DO is the level of DO required for viability of the carps.

“Nutrients” as used herein refers to nutrients like probiotics, prebiotics, minerals, vitamins or any components used for enhancing the quality of water, health and growth conditions of carps/aquatic animals. The term “nutrients” is used interchangeably with drugs or probiotics in embodiments describing the invention.

“Preset Values” “preset range” or “preset configuration” as used herein refers to values of various parameters like Dissolved oxygen (DO), Oxygen Reduction Potential (ORP), Nitrite, nitrate, sulphide, unionized ammonia, ammonia, phosphate, bacteria or vibrio count which can be set manually by a user, retrieved from reference values stored in the cloud, or derived from predicted values by the artificial intelligence module .These values are can vary by waterbody, and/or by objective of deployment of waterbody management system of the invention.

“Reference Values” as used herein refers to the optimal value published in research articles and validated from laboratory experiments and field condition.

“SOD” or Sediment Oxygen Demand as used herein refers to amount of dissolved oxygen required to degraded the waste at the sediment water interface of the waterbody.

“Wastewater” as used herein refers to waste matter in water bodies, can include without limitation, solid waste particles, excess food or feed waste, oxygen depleted water, nutrient depleted water, free radicals, or may comprise any other physical, chemical or biological contaminants. The contaminants may be variable from time to time or based on the industry.

The current invention encompasses a system for autonomous and intelligent management of water bodies, the system comprising an aquaculture system, wherein the aquaculture system further comprises at least one aeration module, a nutrient dispensing module and a sensor module. The current invention provides a cost-effective solution that enables timely and corrective action for water body and aquaculture management using predicted values of a wide range of parameters including water quality parameters as predicted by the artificial intelligence module, based on parameters as sensed by sensors comprised in the sensor module.

In one embodiment, the current invention encompasses a system for autonomous and intelligent management of water bodies, the system comprising:
an aquaculture system, wherein the aquaculture system further comprises at least one aeration module, a nutrient dispensing module and a sensor module;
a communication gateway, wherein the communication gateway is a wireless communication hub which is configured to communicably connect with the aquaculture system;
a cloud computing module, wherein the cloud computing module is configured to connect with the Internet, the communication gateway and the aquaculture system through wired or wireless means; and,
wherein the aeration module, nutrient dispensing module and sensor module in the aquaculture/water management system are each designed to comprise separate batteries as power sources for separate control modules, and wherein the sensor module is further configured with an Artificial Intelligence module. In one embodiment of the invention the control module comprises of a microcontroller/microprocessor and a wifi component.

In one embodiment of the invention, the sensor module comprises a navigation module, a battery and a control module, and wherein the sensing module is an assembly of a plurality of sensors selected from depth sensors, dissolved oxygen (DO) sensors, ORP sensor, GPS sensors, sonar module, temperature sensor, pH sensor, turbidity sensor, proximity sensors, water current velocity measurement sensor, carp velocity sensor, carp acoustics sensors, Inertial Measurement Unit (IMU)sensor.

In one embodiment of the invention,the Artificial intelligence module is configured to predict water quality parameters including, without limitation, DO, ammonia (NH4-N), unionized ammonia,phosphate (PO4-), turbidity, salinity, temperature, pH, TSS (Total Suspended Solids),TOC (Total Organic Carbon) and ORP (Oxidation Reduction Potential), sulphide, phosphate, nitrite, nitrate, vibrio count, Carbon dioxide (CO2) capture, water column respiration rate, carps respiration rate, sediment respiration rate, Carbon to Nitrogen (C:N ratio), frequency of synchronous and asynchronous waves of aerator or a combination thereof on the data input from the sensor module.

In one embodiment of the Artificial intelligence module is configured to predict disease onset in aquaculture species based on the predicted water quality parameters selected from DO, ammonia (NH4-N), unionized ammonia (NH3),phosphate (PO4-), turbidity, salinity, temperature, pH, TSS (Total Suspended Solids),TOC (Total Organic Carbon) and ORP (Oxidation Reduction Potential), sulphide, phosphate, nitrite, nitrate, vibrio count, Carbon dioxide (CO2) capture, water column respiration rate, carps respiration rate, sediment respiration rate, C:N ratio, frequency of synchronous and asynchronous waves of aerator. In one embodiment of the invention the Artificial intelligence module is configured to predict water quality parameters at various locations of the water column and at the sediment water interface .In one embodiment of the invention the sensor module has a sonar module for understanding bathymetry of lakes and reservoirs.

In one embodiment of the invention, sensor module is configured to autonomously move to a plurality of coordinates in a water body along different strata, and wherein the autonomous motion of the sensor module is enabled by inputs from a plurality of sensors selected from GPS IMU, position or proximity sensor comprised in the sensor module, and wherein the autonomous decision-making capability of the sensor module for motion in the water body is enabled by a computer-vision and GPS aspect of the Artificial Intelligence module.

In one embodiment of the invention the sensors are arranged in a sensor block. In one embodiment of the invention the sensor block is cylindrical in shape. In one embodiment of the invention the sensor block houses temperature sensor, DO sensor, ORP sensor, pH sensor, turbidity, reserved hole for optional spectrophotometer, thermocouple, proximity sensors, water current velocity sensor, sonar and the sensor data acquisition system. In one embodiment of the invention housing sensor data acquisition system in the sensor block eliminates the effect of signal attenuation and drift while transmitting analog data over variable and long distance under water. In one embodiment of the invention the sensor module further comprises a navigation motor. In one embodiment of the invention the sensor module further comprises a cooling fan, a display, an up/down motor, a motor drive, and a GPS module. In one embodiment of the invention the camera is waterproof. In one embodiment of the invention the camera captures images of aquatic species and turbidity level.

In one embodiment of the invention, the artificial intelligence module is configured to create a plurality of data training models based on the data input from sensor selected from, without limitation, depth sensors, dissolved oxygen (DO) sensors, IMU sensors, GPS sensors, imaging sensors (computer vision), temperature sensor, water current velocity measurement sensor, weather parameters such as wind speed, wind direction, ambient temperature and humidity at the water surface, for prediction of DO gap, unionized ammonia, anaerobic conditions, or a combination thereof. In one embodiment of the invention the artificial intelligence module trains the captured data of one or more of parameters of DO, turbidity, salinity, temperature, pH and ORP at various locations of the sediment or various levels of a water column to capture a pattern. In one embodiment of the invention, the artificial intelligence module comprises an artificial neural network algorithm, a Gaussian process regression algorithm, a logistical model tree algorithm, a random forest algorithm, a fuzzy classifier algorithm, a decision tree algorithm, a hierarchical clustering algorithm, a k-means algorithm, a fuzzy clustering algorithm, a deep Boltzmann machine learning algorithm, a deep convolutional neural network algorithm, a deep recurrent neural network, or any combination thereof. In one embodiment of the invention, the training data set further comprises process characterization data, in-process inspection data, or post-build inspection data that is generated by an operator while manually adjusting the process control parameters. In one embodiment of the invention the sensor module locally stores the reading taken by the sensors. In one embodiment of the invention the readings are stored on cloud. In one embodiment of the invention the sensor module stores the reference values of water quality parameters, water body parameters. In one embodiment of the invention the artificial intelligence module compares the data captured from the sensors to the reference values. In one embodiment of the invention the readings are stored at the local storage device or in a cloud server.

In one embodiment of the invention, the aeration module comprises an air pumping module, an aerator, a control module and a battery. In one embodiment of invention, the aeration module is designed to be physically placed in a water body and to aerate hypolimnetic or sediment regions of the waterbody based on input from the artificial intelligence module and preset configuration. In one embodiment of the invention, the aerator aerates a sediment or hypolimnetic region by oscillating vertically in a sinusoidal manner, thereby generating standing waves and synchronous waves radially with a frequency and amplitude as determined by the input from the artificial intelligence module. In one embodiment of the invention, the aerator is provided with mechanical wings that are designed to flap, in order to mimic ornithogenic disturbance with a frequency range as determined by the input from the artificial intelligence module. In one embodiment of the invention, the aerator is a one or two-stage ring aerator with diffuser nozzles, a motor, a bearing holder, a spring pipe, a pulley holder a pulley belt, pneumatic pipes and connector configured with the air pumping module of the aeration module. In one embodiment of the invention, one or more aerators/aeration modules are deployed in the water body based on the input of artificial intelligence module.

In one embodiment of the invention the aerator is designed to diffuse air or pure oxygen radially by propagating waves that facilitate in transmission of dissolved oxygen (DO) farther from the location of the device and also enhance mixing of DO at the sediment water interface. In one embodiment of the invention the trained data input to the aeration module optimizes one or more of aeration time, compressor pressure, amount of air to be diffused to the system of aeration module. In one embodiment of the invention the trained data input to the aeration module optimizes the air pump running time. In one embodiment of the invention the trained input data to the aeration module optimizes wave frequency generation of the aeration module. In one embodiment of the invention synchronous or asynchronous waves are generated based on the input from the Artificial intelligence module. In one embodiment of the invention the synchronous waves are generated by the aerator for providing dissolved oxygen to sediment water interface and asynchronous waves are generated for dispersing the waste to the banks of a water body. In one embodiment of the invention, the dispersed waste includes feed waste, excreta toward the embankment/bank of a waterbody by generating asynchronous waves. In one embodiment of the invention the standalone aeration module of the invention comprises a floatable member to keep the system afloat.

In one embodiment the aeration module is energy efficient. In one embodiment of the invention the aeration module standard oxygen transfer rate is 3-4 times faster by vacillating vertically within critical and optimal limits which existing aerators such as fixed bed hypolimnetic aeration systems, blowers and surface aeration systems lack. In one embodiment of the invention the aeration module is mobile and provides adequate oxygen homogeneously to the hypolimnion by generating proper mixing at the sediment water interface. In one embodiment of the invention the aeration module is static for aquaculture. In one embodiment of the invention the aeration module comprises of a navigation module for the lakes or reservoir management. Due to homogenous oxygen transfer and generating waves capability, the aerator is efficient and economical on power consumption and environment friendly in comparison to existing fixed bed systems and surface aerators. In one embodiment of the invention the aeration module disperses waste away from the centre towards the banks of the waterbody. In one embodiment of the invention, aeration module disperses waste away from the centre towards the banks of the waterbody by generating asynchronous waves in the range of 0.005 to 2 Hz. In one embodiment of the invention multiple aeration modules are deployed at a time.

In one embodiment of the invention the aeration module can balance itself by adjusting propeller speeds and direction during the wave generation process by using artificial intelligence in its Proportional-Integral-Derivative controllers. In one embodiment of the invention the aeration module is designed to start aeration to meet the gap between existing DO levels and SOD demand. In one embodiment of the invention the gap between existing DO levels and DO demand varies at different coordinates of a water body. In one embodiment of the invention the gap between existing DO levels and SOD demand varies by stages of the aquaculture. In one embodiment of the invention the stages of aquaculture include various growth points of aquatic animals. In one embodiment of the invention the aeration module starts aeration based on DO gap of 3-6 ppm at the sediment water interface. In one embodiment of the invention the aeration module starts aeration based on DO gap or ORP sensor value or a combination thereof at the sediment water interface as predicted by artificial intelligence module. In one embodiment of the invention the aeration module starts aeration based on DO gap, 0<ORP < -50mv, or a combination thereof.

In one embodiment of the invention, the nutrient dispensing module comprises a nutrient dispenser, a navigation module, a control module. In one embodiment of the invention, nutrient dispensing module is configured to autonomously move to a plurality of coordinates in a water body along different strata, and wherein the autonomous motion of the sensor module is enabled by inputs from a plurality of sensors selected from GPS, IMU, position or proximity sensor comprised in the nutrient dispensing module, and wherein the autonomous decision-making capability of the sensor module for motion in the water body is enabled by a computer-vision and GPS. In one embodiment of the invention, the nutrient dispensing module comprises at least two valves and two tanks, and wherein, at least one of the tanks is detachable. In on embodiment of the invention, the navigation module of the nutrient dispensing module further comprises an accelarometer and a gyroscope.

In one embodiment of the invention the input from the Artificial Intelligence module to the nutrient dispensing module in the form of trained data optimizes a plurality of parameters selected from time interval between dispensing nutrients, amount of nutrients to dispense, or the type of nutrients to be dispensed or a combination thereof.

In one embodiment of the invention, the control module in the nutrient dispensing module is configured to enable dispensing of drugs or probiotics when the concentration of unionized ammonia, nitrite, nitrate, sulphide, phosphate, vibrio count in the water body is observed to be in a range different from the preset range, and wherein, the sensor module is configured to sense the values of DO, pH, ORP, temperature, turbidity. In one embodiment of the invention the artificial intelligence module is configured to predict the unionized ammonia, nitrite, nitrate, sulphide, phosphate, vibrio growth from the sensed parameters of DO, pH, ORP, temperature, turbidity as sensed by the sensor module. In one embodiment of the invention the artificial intelligence module determines the timings and dosage of nutrients to be dispersed into the water body.

In one embodiment of the invention the nutrient dispensing module dispenses drugs or probiotics when unionized ammonia concentration is in the range of 0.01 ppm to 0.05 ppm, sulphide >20 µg/L, phosphate in the range of more than 25 ppm and/ C:N ratio >30 as predicted by sensor module at the sediment water interface. In one embodiment of the invention the nutrient dispensing module dispenses drugs or probiotics when unionized ammonia concentration is > 0.025 ppm, and/ sulphide > 20 µg/L, phosphate > 25 ppm, and C:N ratio >30 as predicted by sensor module at the sediment water interface. In one embodiment of the invention, the nutrient dispensing module dispenses nutrients, drugs or probiotics when and/ C:N ratio >30, sulphide>20 µg/L and, phosphate>25 ppm and unionized ammonia >0.025 ppm and/or DO < 3 ppm and ORP < -25 mv, 6.8<pH<8.5 etc and a combination thereof. In one embodiment of the invention the nutrients include without limitation probiotic, prebiotics, microalgae, marine bacteria, lactic acid bacteria, Vibrio species, Bacillus sp., alum, peptides, proteins, antibodies, therapeutics or a combination thereof. In one embodiment of the invention the nutrient dispensing module enables mixing of food with water and releases at desired depth. or spray at the surface or water for different strata of any confined water body. In one embodiment of the invention the nutrient dispensing module modulates evapotranspiration by spraying thin film on top of the water surface. In one embodiment of the invention, the desired values of Total Vibrio Count (TVC) varies from 103 CFU/mL to 104 CFU/mL at the sediment water interface.In one embodiment of the invention, the desired values of green Vibrio colonies is 102 CFU/mL and for yellow Vibrio colonies is 103 CFU/mL at the sediment water interface.

In one embodiment of the invention the nutrient dispensing module further comprises of a bioreactor module. In one embodiment of the invention the bioreactor module provides conditions suitable for growth of beneficial bacteria. In one embodiment of the invention the bioreactor module creates a vortex motion enabling circulation of medium for optimal bacterial growth. In one embodiment of the invention the bioreactor is a detachable module. In one embodiment of the invention the bioreactor module manoeuvres based on inputs from sensor module. In one embodiment of the invention the bioreactor module manoeuvres based on manual input.

In one embodiment of the invention, the nutrient dispensing module and the sensor module work in an integrated manner to locate the coordinates of nutrient dispersal in a water body.

One embodiment of the current invention is a method for autonomous and intelligent management of water bodies, the method comprising:
placing an aquaculture system in a water body, wherein the aquaculture system comprises at least one aeration module, a dispensing module and a sensor module, and wherein, a wireless communication hub is configured to communicably connect with the control modules in the aquaculture system;
determining a plurality of physical parameters of the water body through activation of a plurality of sensors in the sensor module;
analyzing the readings from the plurality of sensors in a cloud computing module enabled by the wireless communication hub;
providing suitable data as inputs to the Artificial Intelligence module in the sensor module for training data;
providing the output of the Artificial Intelligence module as command input to the aeration module and dispensing module;
navigating the sensor module or the dispensing module to suitable locations on the water body based on the inputs from Artificial Intelligence module;
activating at least one of the aeration module nearby to the coordinates or the dispensing module at the coordinates; and,
analyzing the change in the physical parameters of the water body at the location and deactivating the aeration module or the dispensing module.

In one embodiment of the invention, the method for autonomous and intelligent management of water bodies comprises a the method of operation of the sensor module includes positioning the sensor module autonomously in a suitable location or grid point in the waterbody; sensing water depth, water quality parameters and velocity of the carps at each grid point; measuring the changes in SOD, water quality parameters and weather information of the location and communicating the inputs to the Artificial Intelligence module; predicting the SOD for a preset future period and deciding the feeding pattern, the frequency of aeration oscillation, duration of aeration by a network of aerators, the type of probiotics to be dispensed and its dispensation parameters; and, checking whether a preset critical value of SOD,unionized ammonia, nitrite, nitrate, phosphate, sulphide, vibrio count and ORP have been attained at the location in the water body; when the critical value is sensed, then activating aeration and dispensing, and deactivating them when the preset conditions are satisfied.

In one embodiment of the invention, the intelligent water body management system of the invention comprises a plurality of end user devices, wherein the end user devices are configured with applications to remotely connect with the aquaculture system.

In one embodiment of the invention, the end user devices include, without limitation, mobiles, smartphones,a tablet, PC, laptop, desktops, wearable devices, mobile handheld devices.

In one embodiment of the invention the modules of the intelligent water body system of the invention operate on renewable energy. In one embodiment of the invention the modules operates on electricity or biofuel or solar energy or a combination thereof.

In one embodiment of the invention the intelligent waterbody management system of the invention is used for reservoir management, lake management or aquaculture body management.

In one embodiment of the invention the aeration module and the nutrient dispensing module function in an integrated manner enhancing the overall efficiency of the system encompassed in the invention. In one embodiment of the invention the aeration module and the nutrient dispensing module function in a lake or reservoir management by controlling and stabilizing dissolved oxygen at the sediment water interface. In one embodiment of the invention the aeration module controls the DO at the sediment by aeration and nutrient dispensing module disperses nutrients, drugs or probiotics. In one embodiment of the invention the aeration module and the nutrient dispensing module function in aquaculture management by regulating DO levels at the sediment to desired DO levels before the feeding module disperses food. In one embodiment of the invention the aeration module infuses the DO to bridge the gap of DO of 4 ppm at the sediment water interface before food dispersal. In one embodiment of the invention the aeration modules disperses feed waste and excreta to the shore/banks of water bodies by generating synchronous waves. In one embodiment of the invention the aerator module helps in mixing of the food or the drugs or the chemicals or nutrients or probiotics to their desired concentrations by generating synchronous waves.

In one embodiment of the invention, the intelligent water body management system of the invention further comprises a water recycling module. In one embodiment, the water recycling module is comprised in the aquaculture system of the intelligent water body management system. In one embodiment of the invention the water recycling module is excluded as a part of intelligent water body management system of the invention for reservoir and lake management

In one embodiment of the invention the water recycling module comprises of a control module, at least one screening tank, a mixing and aeration tank and a battery. In one embodiment of the invention the control module comprises a communication module. In one embodiment of the invention, the control module comprises of a microcontroller and a wifi component. In one embodiment of the invention, the volume of screening tank filled with waste water is based on input from the sensor module. In one embodiment of the invention, one or more screening tanks are perforated and retain waste from the collected waste water. In one embodiment of the invention, the screening tanks retain waste of size 1 mm or greater. In one embodiment of the invention, the screening tanks retain waste of size 1 cm or greater. In one embodiment of the invention the artificial intelligence module of the sensor module is configured to send trained data input to the mixing and aeration tank for mixing of one or more nutrients, probiotics, drugs or disinfectants or a combination thereof. In one embodiment of the invention, the mixing and aeration tank mixes of one or more nutrients, probiotics, drugs or disinfectants or a combination thereof by creating a vortex. In one embodiment of the invention, the mixing and aeration tank comprises an aerator and a DO sensor. In one embodiment of the invention the embodiment, the mixing and aeration tank dispenses the recycled water to the water body. In one embodiment of the invention the recycled water has optimal amount of one or more of probiotics, beneficial microbes, nutrients, microalgae, drugs or disinfectants. In one embodiment of the invention the optimal amount of one or more of probiotics, beneficial microbes, nutrients, microalgae, drugs or disinfectants is determined based on one or more parameters including the weight of waste in the screening tank, concentration of Dissolved Oxygen (DO), ammonia(NH4-N), unionized ammonia, pH, TOC, Total Dissolved Solids(TDS), salinity, temperature at the sediment. In one embodiment of the invention the recycled water has amount of DO at 6 ppm or more, NH4-N amount of not more than 0.1 mg/l, TDS 2.5%, Total Suspended Solids (TSS) 400 ppm, pH 8. In one embodiment of the invention the water recycling module further comprises of an electrical module. In one embodiment of the invention the electrical module relays electrical signals for pumping water. In one embodiment of the invention, the sensor module comprises a mopping module, wherein the mopping module is configured to collect waste from the sediment and transfer the waste to the screening tank. In one embodiment of the invention, the mopping module collects waste from the sediment without making the water body turbid. In one embodiment of the invention, the mopping module comprises a vacuum suction pump wherein the vacuum suction pump is configured with the Artificial intelligence module.

The following examples illustrate the invention without limiting its scope.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications. However, all such modifications are deemed to be within the scope of the claims.

### EXAMPLES

### Example 1

### Calibration of Sensors in Sensor Module Based on Input From AI Module

DO, pH and ORP sensors were deployed through the sensor module. When DO value between 3<DO<4 ppm,the ORP shows -50mv<ORP<0 and pH between 5<pH<8. This condition is attributed to anaerobic conditions where unionized ammonia values were predicted in the range 0.1<NH3<0.21 ppm. The AI module also repredicted DO value and the value was checked to find the difference in DO value predicted and actually captured from the sensor. If the difference between DO value measured by sensor and DO predicted by Artificial intelligence module is in the range of 0.20- 0.3 ppm constantly for 2 hrs, the prediction corrects the sensor value and flags an alert for calibration and cleaning of sensors.

### Example 2

### Prediction of Unionized Ammonia, Phosphate, Sulphide and Dispensing of Probiotics/Nutrients

In some conditions, when sensors predicted 2<DO<3ppm,the ORP values -50mv<ORP<0 and and 6.5<pH<7.5, the unionized ammonia were predicted in the range 0<NH3<0.2 ppm, or phosphate >20 ppm, sulphide >20 µg/L or a combination thereof. Probiotics were dispensed by the dispenser of the nutrient dispensing module to balance levels of unionized ammonia, phosphate and sulphide.

### Example 3

### Aerator Module Functionality Based on Artificial Intelligence Module

It was observed when the sensor values of DO were 4.8<DO<6.4 ppm, the ORP values were, 5mv<ORP<20mv and pH between 6.5<pH<8.5, the aeration module was activated to fill the gap. It was observed that accumulation waste as localised due to stagnation points at the sediment where DO value ranged between 3.5<DO<4.5 ppm, ORP shows -5mv<ORP<15mv, and unionized ammonia between 6.5<pH<8.5, phosphate > 20 ppm, sulphide >20 µg/L as predicted by the Artificial Intelligence module. The unflapped network aerator oscillated with a frequency of 2 Hz to 6 Hz in a phase difference of 90 -180 degrees, while ornithogenic aerator flapped with frequency ranging from 2 Hz to 6 Hz and in a phase difference of 90 -180 degrees to generate asynchronous waves. The phase difference is to create a lag of generating wave such as one wave reaches one destination before second device starts generating wave. The change of frequency was predicted by an AI model of monitoring module taking input data of weather, and sediment water quality parameters.

We claim:

1. A system for autonomous and intelligent management of water bodies, the system comprising:
an aquaculture system, wherein the aquaculture system further comprises at least one aeration module, a nutrient dispensing module and a sensor module;
a communication gateway, wherein the communication gateway is a wireless communication hub which is configured to communicably connect with the aquaculture system;
a cloud computing module, wherein the cloud computing module is configured to connect with the Internet, the communication gateway and the aquaculture system through wired or wireless means; and,
wherein the aeration module, nutrient dispensing module and sensor module in the aquaculture system are each designed to comprise separate batteries as power sources for separate control modules, and wherein the sensor module is further configured with an Artificial Intelligence module.

2. The system according to claim 1, wherein the sensor module comprises a sensing module, a navigation module, a battery and a control module, and wherein the sensing module is an assembly of a plurality of sensors selected from depth sensors,dissolved oxygen (DO) sensors, ORP sensor, GPS sensors, sonar module, temperature sensor, pH sensor, turbidity sensor, proximity sensors, water current velocity measurement sensor, carp velocity sensor, carp acoustics sensors, IMU sensor.

3. The system according to claim 1, wherein the sensor module is configured to autonomously move to a plurality of coordinates in a water body along different strata, and wherein the autonomous motion of the sensor module is enabled by inputs from a plurality of sensors selected from GPS, IMU, position or proximity sensor comprised in the sensor module, and wherein the autonomous decision-making capability of the sensor module for motion in the water body is enabled by a computer-vision and GPS aspect of the Artificial Intelligence module.

4. The system according to claim 1, wherein the Artificial Intelligence module is configured to create a plurality of data training models based on the data input from sensors selected from depth sensors, turbidity sensor, dissolved oxygen (DO) sensors, IMU sensors, GPS sensors, imaging sensors or computer vision, temperature sensor, ORP sensor, water current velocity measurement sensor, weather parameters such as wind speed, wind direction, ambient temperature and humidity at the water surface, for prediction of DO gap, unionized ammonia, anaerobic conditions or a combination thereof.

5. The system according to claim 1, wherein the Artificial intelligence module is configured to predict water quality parameters selected from DO, ammonia (NH4-N), unionized ammonia,phosphate (PO4-), turbidity, salinity, temperature, pH, TSS (Total Suspended Solids),TOC (Total Organic Carbon) and ORP (Oxidation Reduction Potential), sulphide, phosphate, nitrite, nitrate, vibrio count, Carbon dioxide (CO2) capture, water column respiration rate, carps respiration rate, sediment respiration rate, C:N ratio, frequency of synchronous and asynchronous waves of aerator based on the data input from the sensor module.

6. The system according to claim 1, wherein the Artificial intelligence module is configured to predict disease onset in aquaculture species based on the predicted water quality parameters selected from DO, ammonia (NH4-N), unionized ammonia, turbidity, salinity, temperature, pH, TSS (Total Suspended Solids),TOC (Total Organic Carbon) and ORP (Oxidation Reduction Potential), sulphide, phosphate, nitrite, nitrate, vibrio count, Carbon dioxide (CO2) capture, water column respiration rate, carps respiration rate, sediment respiration rate, C:N ratio, frequency of synchronous and asynchronous waves of aerator.

7. The system according to claim 1, wherein the aeration module comprises an air pumping module, an aerator, a control module and a battery, and wherein, the aeration module is designed to be physically placed in a water body and to aerate hypolimnetic or sediment regions of the waterbody based on input from the artificial intelligence module and preset configuration.

8. The system according to claim 7, wherein, the aerator is designed to aerate a region by oscillating vertically in a sinusoidal manner, thereby generating standing waves and synchronous waves radially with a frequency and amplitude as determined by the input from the artificial intelligence module.

9. The system according to claim 7, wherein, the aerator is provided with mechanical wings that are designed to flap, in order to mimic ornithogenic disturbance with a frequency range as determined by the input from the artificial intelligence module.

10. The system according to claim 7, wherein, the synchronous waves are generated by the aerator for providing dissolved oxygen to sediment water interface and asynchronous waves are generated for dispersing the waste to the banks of a water body.

11. The system according to claim 6, wherein the aerator is a one or two-stage ring aerator with diffuser nozzles, a motor, a bearing holder, a spring pipe, a pulley holder a pulley belt, pneumatic pipes and connector configured with the air pumping module of aeration module.

12. The system according to claim 1, wherein the nutrient dispensing module comprises a nutrient dispenser, a navigation module, a control module, a bioreactor and wherein, the nutrient dispensing module is designed to be physically placed in a water body and to autonomously move to a plurality of coordinates in a water body and dispense a plurality of nutrients housed in the dispensing module.

13. The system according to claim 10, wherein the autonomous motion of the nutrient dispensing module is enabled by inputs from a plurality of sensors selected from GPS, IMU, position or proximity sensor comprised in the nutrient dispensing module, and wherein the autonomous decision-making capability of the nutrient dispensing module for motion in the water body is enabled by a computer-vision and GPS.

14. The system according to claim 1, wherein the input from the Artificial Intelligence module to the nutrient dispensing module in the form of trained data optimizes a plurality of parameters selected from time interval between dispensing nutrients, amount of nutrients to dispense, or the type of nutrients to be dispensed or a combination thereof.

15. The system according to claim 1, wherein the nutrient dispensing module comprises at least two valves and two tanks, and wherein, at least one of the tanks is detachable.

16. The system according to claim 12, the control module in the nutrient dispensing module is configured to enable dispensing nutrients, drugs or probiotics when the concentration of unionized ammonia, nitrite, nitrate, sulphide, phosphate, vibrio count in the water body is observed to be in a range different from the preset range, and wherein, the sensor module is configured to sense the value of DO, pH, ORP, Temperature, turbidity and the artificial intelligence module is configured to determine the timings and dosage of nutrients to be dispersed into the water body.

17. The system of claim 1, wherein the aquaculture system further comprises a water recycling module and wherein the water recycling module comprises an inlet, at least one screening tank, a mixing and aeration tank, a control module and a battery.

18. The system of claim 17, wherein the Artificial intelligence module is configured with a mopping module comprised in the sensor module and wherein the mopping module collects waste water from the sediment.

19. The system of claim 17, wherein the mixing and aeration tank adds one or more of drugs, nutrients, disinfectants, micro algae, or probiotics to water received from the screening tank based on inputs received from the artificial intelligence module by creating a vortex and dispenses recycled water.

20. The system of claim 17, wherein the water recycling module is excluded as a part of the aquaculture system for reservoir and lake management.

21. The system of claim 1, wherein the system comprises a plurality of end user devices and wherein, the end user devices are configured with applications to remotely connect with the aquaculture system.

22. A method for autonomous and intelligent management of water bodies, the method comprising:
placing an aquaculture system in a water body, wherein the aquaculture system comprises at least one aeration module, a dispensing module and a sensor module, and wherein, a wireless communication hub is configured to communicably connect with the control modules in the aquaculture system;
determining a plurality of physical parameters of the water body through activation of a plurality of sensors in the sensor module;
analyzing the readings from the plurality of sensors in a cloud computing module enabled by the wireless communication hub;
providing suitable data as inputs to the Artificial Intelligence module in the sensor module for training data;
providing the output of the Artificial Intelligence module as command input to the aeration module and dispensing module;
navigating the sensor module or the dispensing module to suitable locations on the water body based on the inputs from Artificial Intelligence module;
activating at least one of the aeration module nearby to the coordinates or the dispensing module at the coordinates; and,
analyzing the change in the physical parameters of the water body at the location and deactivating the aeration module or the dispensing module.

23. The method according to claim 21, wherein the method of operation of the sensor module includes positioning the sensor module autonomously in a suitable location or grid point in the waterbody; sensing water depth, water quality parameters and velocity of the carps at each grid point; measuring the changes in SOD, water quality parameters and weather information of the location and communicating the inputs to the Artificial Intelligence module; predicting the SOD for a preset future period and deciding the feeding pattern, the frequency of aeration oscillation, duration of aeration by a network of aerators, the type of probiotics to be dispensed and its dispensation parameters; and, checking whether a preset critical value of SOD,unionized ammonia, nitrite, nitrate, phosphate, sulphide, vibrio count and ORP have been attained at the location in the water body; when the critical value is sensed, then activating aeration and dispensing, and deactivating them when the preset conditions are satisfied.
